(19) United States
(12) Patent Application Publication
(10) Pub. No.: US 2003/0086338 A1
(43) Pub. Date: May 8, 2003

(54) Wireless web based drug compliance system

(76) Inventors: Srikonda V. Sastry, Sunnyvale, CA (US); Manohar Katakam, Bourbonnais, IL (US); Orton E. Snyder, San Jose, CA (US)

Correspondence Address: Donald W. Meeker, #512, 750 La Playa, San Francisco, CA, 94121, US

(21) Appl. No.: 10/291,077

(22) Filed: Nov. 8, 2002

Related U.S. Application Data
(60) Provisional application No. 60/344,524, filed on Nov. 8, 2001.

(51) Int. Cl. G04B 47/00

(52) U.S. Cl. 368/10

(57) ABSTRACT

A wireless, web based system for monitoring patient drug compliance includes a plastic container that holds a wireless device, the patient's drugs, and a cpu programmable remotely and automatically from normal computer input by health care providers and pharmacists to control the functioning of the wireless transceiver and a variety of sound, vibration, light and readable screen for reminders and to provide drug related information. A sensor detects and wirelessly reports the opening of the medicine container in real time to remind the patient, when noncompliance occurs, on the patient's portable device and also telephones or pages. the patient as additional reminders. The web site program analyzes models and interprets the data to provide important drug non-compliance information to healthcare professionals. The container may further comprise a sensor means for temperature, blood pressure, and blood chemistry data including blood glucose, creatinine and others which may all be transmitted wirelessly

### CLAIM OF PROVISIONAL APPLICATION RIGHTS

This application claims the benefit of U.S. Provisional Patent Application No. 60/344,524, filed on Nov. 8, 2001.

### BACKGROUND OF THE INVENTION

1. Field of the Invention

The present invention relates generally to drug compliance systems and more specifically it relates to a two-way communication wireless medicine container with passive monitoring of compliance interconnected wirelessly with a web site and health care providers and pharmacists with an automatic feedback means of contacting a non-compliant patient in real time.

2. Description of the Prior Art

While prescription drugs are modern miracles in preserving and extending a person's life, not taking prescriptions as required (non-compliance) has become a major health problem.

Non-compliance in prescription drug taking is putting an enormous strain on the entire health care system today. Estimates of cost to the United States economy range from 50 to as high as 100 billion dollars per year. It is estimated that 17 percent of all Emergency room visits are the direct result of a prescription drug misadventure (non-compliance). Other results of non-compliance include hospital and nursing home admissions as well as lost wages and lower productivity.

It can be appreciated that drug containers have been in use for many years. Drug compliance reminder devices are a more recent development. Typically, drug containers are comprised of various types of bottles and other devices designed to hold medication. Drug compliance reminder devices currently consist of various electronic and mechanical timers and pagers.

The main problem with conventional drug compliance devices is a lack of real time interactivity from the patient, the patient's doctor and the pharmacist with regard to the patient's drug compliance. Another problem with conventional drug compliance devices is that the devices are not wireless, hence they are not portable, and require the patient's active input to operate. Or, if they are wireless, then they are only pager units that do not hold the patient's medication. A final problem with conventional drug compliance devices is that they are expensive and the cost for the device is borne by the patient/consumer.

U.S. Pat. No. 6,380,858, issued Apr. 30, 2002, U.S. Pat. No. 6,294,999, issued Sep. 25, 2002, and U.S. patent application Ser. No. 2002/0067270, published Jun. 6, 2002, and U.S. patent application Ser. No. 20020027507, published Mar. 7, 2002, all to Yarin, et al., provide systems and for facilitating effective self-management of medication treatment by patients. A Smart Tray monitors and reports to third parties a patient's compliance with various medication treatment regimens. Medication containers are provided with electromagnetic tags that provide various information about medicament contained within a respective container. A Smart Tray is equipped with a processor and reader that interrogates each respective electromagnetic tag to identify medicament(s) contained within each container. Using the retrieved information, a Smart Tray provides visual and/or audio signals to a patient to remind the patient when and how much of various medicaments to take. A Smart Tray also monitors, via the reader, when a medication container is removed. A Smart Tray can communicate with one or more third parties, such as healthcare providers, pharmacies, and other suppliers of healthcare products and services via a computer network. In addition, a Smart Tray can communicate with various appliances and can modify medication regimens for particular medicaments in response to data received from various appliances. This patent includes only limited range wireless RFID tag reading communication between a pill container and the tray which may not be carried about or worn by the patient in daily activities. This device needs the pill bottle to be placed into the tray every time the data has to be transmitted from the bottle. If the bottle is not returned to the tray, bottle by itself cannot communicate with the network system

U.S. patent application Ser. No. 20020104848, filed Feb. 5, 2001 by Burrows, is for a container having signaling capability for use with medicine and other pharmaceutical related products. The container preferably includes a conventional bottle-type body with a rotatably secured closure. A sensor means is structured to determine the position of the closure and thereby provide an indication of cap rotation indicative of the patient using the medicine. A processing means and display means are also included in the container to provide an indication of the current state of the container with respect to its contents. In addition, the container can include a button means to permit a user of the container to scroll through indicia shown on the display means. In another aspect of the container, a base station is provided for transmitting data to/from a signal means incorporated into the container. The base station includes a body having at least one receptacle for suitably receiving a container therein. A method of using the container is also provided. The bottle has to be placed on the base station for the data transfer. The base station has to be connected to the wall telephone line (wired) for the unit to communicate to the network or web. The cap is rotatable or snap on but not child-resistant type. The display does not refer to the presentation of drug: drug interactions of prescribed doses. A special label is needed to communicate, therefore adding more burden to the pharmacist to program it or prepare it. This is wired system, a base station is needed and it has a modem to communicate to the network or it may use a network card. To program the bottle at the pharmacy a base station is needed at the pharmacy. The patient also needs a base station to transfer the data. There is no means of correcting the missed dose, such as reminding the patient, since the bottle alone cannot communicate with the web without the base station. Data upload beyond connecting to the base station is not disclosed. The system overall is bulky with several disadvantages.

U.S. Pat. No. 5,802,014, issued Sep. 1, 1998 to Danko, provides a strap-on tablet dispensing system including a system unit providing timing and alarm functions, a strap arrangement, and a plurality of tablet containers fixed to the strap arrangement. The tablet dispensing system is arranged to hold a plurality of tablet medications and indicate to the wearer, via prompts, the proper times to ingest one or more tablets from one or more tablet containers. A plurality of microswitches are also be provided to enable the system to verify that the indicated tablet container or containers are accessed. The tablet dispensing system may be arranged to support the downloading of programming and configuration information directly from a host computer into the tablet dispensing system. This patent describes a wireless device. If a minimum of 10 days prescription with multiple drugs is provided, the system in the invention becomes too bulky to wrap around wrist, hand or neck. Active data input from the patient by pressing the buttons on the system is needed to indicate the patient has taken the dose. This is a burden on patient as opposed to track the dose administration compliance passively. Even though the patent mentions wireless communication and specifies an optical communication port, the system only uses the infrared or some light based communication for the programming and signaling. This method dictates that the system be in close proximity to the reader controller to upload or download the data. If there is any obstruction between the pill watch and the IR reader, the communication will not occur. The pharmacist/nurse/any healthcare provider must be trained in programming to configure this system

U.S. Pat. No. 6,421,650, issued Jul. 16, 2002 to Goetz et al, is for a medication management system which includes three components to assist a patient control, monitor and manage administration of prescribed medications. The system comprises a patient component having a retrievable patient database of patient medical history, prior prescribed medications and current prescribed medications, and it includes a data transfer interface, e.g., a hardwired interface, such as an RS232 interface or infrared data transfer port. The system also includes a physician component having a retrievable physician's database of medication information and an input/output device enabling a prescribing physician to enter prescription information into the physician component. The physician's database is capable of receiving and storing patient data transferred from the patient component through said data transfer interface. The system finally also includes a pharmacist component resident on a pharmacist's computer. The pharmacist's computer is adapted to interface with said patient component to transfer prescription data to said pharmacist component. At least one of or each of the physician component and the pharmacist component has the capability of searching a medication database to determine potential medication interactions with currently prescribed medications and identify those to the physician or pharmacist for selective downloading to the patient component so that the patient can be alerted to the potential interactions. The patient component has a scheduler which tracks a plurality of medication dose schedules and includes alarm functions to prompt a patient to take particular medications, reschedule them, and alert the patient to potential interactions between medications and/or provide caution information to the patient for administration of the medication. The invention here is mostly an electronic gadget and cannot contain medication and therefore works simply as a reminding system. Also the system by itself can not communicate wirelessly with the health care provider or any central station. Due to several electronic modules the system may be expensive. Above all the system needs the patient's active input for dose administration data collection.

U.S. Pat. Nos. 6,150,942, issued Nov. 21, 2000 and 5,963,136, issued Oct. 5, 1999 both to O'Brien, are for an interactive prescription compliance, and life safety system providing remote and on site verification of procedures related to the health status of a person, including taking of medicines, responsiveness to queries, and attendance of health care and service providers in the home by providing for signals to and from a person's location, with alarm activation when a deviation from a preprogrammed procedure occurs. The O'Brien invention needs a set up box which is connected via wire, modem and Ethernet to communicate and uses a very limited local barcode reader or RFID technology rather than a true long distance wireless communication system. The said system however, is not a portable or wearable system by the user. The system needs several complex sub systems to function such as RFID readers, a set top box and multiple packet containers for dosage housing. The system also needs a modem and Ethernet base T converter, which are wired systems, for the communication of compliance data.

U.S. Pat. No. 5,852,408, issued Dec. 22, 1998 to Christiansen, provides a system including a medication dispensing device that is adapted for dispensing a medication to a patient at a predetermined time interval and includes a method for the detection of the timely removal of the medication from the device. When the medication is not timely removed from the device a signal of non-compliance is generated and is received by an alarm system that is adapted to summon help. According to a first embodiment the alarm system places a telephone call to a care-giver or, if the care-giver is unresponsive, to an alternate care-giver who in turn makes contact with the patient. According to a second embodiment the alarm system places a telephone call to a central monitoring station which attempts to make contact with the patient by use of a two-way speaker phone that is included in the alarm system. In the event the patient is unresponsive to communication over the speaker phone, a person at the central monitor station places a telephone call to a care-giver or, if the care-giver is unresponsive, to an alternate care-giver who in turn makes contact with the patient. According to an alternative embodiment the alarm system is incorporated into the medication dispensing device as a component thereof. However, the invention needs several reception means for communication and transfer of data. Also the invention does not use wireless technology for the long distance communication and transmission of compliance data. The invention needs the alarm, outside or inside the medicine container, needs to be connected to the regular telephone wires for the communication to the alerting agency or healthcare provider. Besides, the invention needs active input from patient after the dose administration.

U.S. Pat. No. 4,939,705, issued Jul. 3, 1990 to Hamilton, et al., claims a device for detecting the dispensing of drugs from a container in a way which eliminates false detection events due to mishandling of the container is disclosed. The device includes a container which may be opened and closed. It also contains a means for detecting the opening and separately detecting the closing of the container as well as means for measuring the time between these events and comparing this elapsed time to a predetermined standard indicative of drug dispensing event. The times of proper drug dispensing events are stored in the device for use by the health care professional following the patient's drug dosing compliance. Other opening and closing intervals which fall outside this time range give rise to an alternative response. They may be recorded with a notation of their probable error or they may be disregarded. In other aspects, the invention provides a preferred physical configuration for the electronic components of the device and a preferred means for accessing the data stored in the device. The system by itself cannot wirelessly communicate the details of compliance with any external system including a web server and it is a very large non-portable pill dispensing system.

U.S. Pat. No. 6,263,259, issued Jul. 17, 2001 to Bartur, indicates a medication dispensing and monitoring system including an acknowledge-back pager, a carriage communicating with the pager, and a medication unit dispensing stored medication. The pager receives prescriptions and transmits messages back to a physician or health care organization. Prescriptions received by the pager are stored and processed by a pager processor. The pager processor communicates with a carriage controller via a series of electrical contacts. At a prescribed time, a motor in the carriage causes the medication unit to dispense the prescribed medication. Numerous medication units may be assembled to accommodate different forms of medication. It is not a portable system but is a considerably large pill dispensing system. It dispenses pills at specified times but has no mechanism to ensure those pills indeed were picked up by patient which in turn cannot translate to patient passive input for dose administration. The invention provides a very cumbersome design with several mechanical and moving parts such as a motor, pulleys and other units, and it requires specific canisters to be used rather than standard prescription bottles. The dispenser is connected to a computer for data access and then to the internet via an interface box or modem. The system cannot correct the non-compliance in real time, it only reminds a patient to take a dose per programmed instruction on the CPU. patient has to notify the doctor/pharmacist regarding the contraindications/side effect as opposed to doctor/pharmacist notifying the patient. There is no means of dose administration data collection and sharing with healthcare provider for further education of the patient or the public or the health care industry.

U.S. Pat. No. 6,332,100, issued Dec. 18, 2001 to Sahai, et al., concerns a medication dispensing system comprising a programmable on-site medication dispensing unit and a central monitoring facility. The on-site medication dispensing unit holds medication in a plurality of canisters which it selects from according to an entered and stored prescription regimen and then notifies the patient by an audible or other sensory signal. If the patient presses a button within a prescribed time, the unit dispenses the selected canisters. If the patient does not press the button within the prescribed time, or if the unit detects a failure to dispense the selected canister, the unit makes the canister inaccessible and contacts, in order, a predetermined list of caregivers and then a central monitoring facility. An audio message is downloaded from the central monitoring facility to one or more of the on-site dispensing units, and played in accordance with a downloaded play program.

U.S. Pat. No. 5,791,594, issued Oct. 26, 1999 to Sahai et al, is for a medication dispensing system comprising an on-site medication dispensing unit and a central monitoring facility. The on-site medication dispensing unit holds medication in a plurality of canisters which it selects from according to an entered and stored prescription regimen and then notifies the patient by an audible or other sensory signal. If the patient presses a button within a prescribed time, the unit dispenses the selected canisters. If the patient does not press the button within the prescribed time, or if the unit detects a failure to dispense the selected canister, the unit makes the canister inaccessible and contacts a predetermined list of caregivers and then a central monitoring facility. Both inventions are dispensing systems, therefore, not portable systems by a patient or user. The systems call for active input by the patient. Besides, the system is a wired system for communication. Also it needs a separate wireless communication system to be worn by patient for the communication link between patient and dispenser.

The above mentioned patents and other patents refer to the use of wireless technology in a non specific fashion. However, in a broader generally accepted definition, wireless means a network of terminals that uses electromagnetic waves (including RF, IR, Laser, visible light and acoustic energy) rather than wire conductors for telecommunications. Therefore, this electromagnetic spectrum is a range of frequencies from zero to infinity. However, this spectrum by custom and practice was formerly divided into 26 alphabetically designated bands. This usage still prevails to some degree but has a frequency of 30 Hz to 3000 GHz. Wireless telephone technology includes cell phones, pagers, GPS, cordless computer peripherals, cordless telephone sets, home entertainment system control boxes, remote controls, two way radios, baby monitors, satellite television and wireless LANs. More specialized exotic wireless systems are GSM, GPRS, EDGE, UMTS, WAP, iMODE, TDMA, CDMA, PCS and so on. Another popular wireless technology known as Blue Tooth technology is a computing and telecommunications industry specification protocol only. This technology provides only a 10 meter personal bubble that supports simultaneous transmission of both voice and data for multiple devices only. It cannot go beyond even though it is wireless. Therefore, just the use of the wireless term does not cover all the technologies which are currently available. The use of term wireless is just convention and conveniently misguiding in the prior art.

Most of the inventions are bulky to carry and non portable or non wearable. They impose the burden of inputting the data by the patient to convey the compliance of dose administration even though as false input may be provided by patient.

What is needed is a real-time transportable two-way communication wireless modified medicine container in a system for passive monitoring of compliance interconnected with a web site (residing on the world wide web or an internet such as LAN or WAN) and health care providers and pharmacists with an automatic feedback means of contacting a non-compliant patient in real time using existing infrastructures and current health care practices.

### SUMMARY OF THE INVENTION

A primary object of the present invention is to provide a wireless, web based portable/wearable drug compliance system that will overcome the shortcomings of the prior art devices and provide a real-time transportable two-way wireless communication modified medicine container in a system for passive monitoring of compliance interconnected with a web site and health care providers and pharmacists with an automatic feedback means of contacting a non-compliant patient in real time using existing infrastructures and current health care practices.

A related object of the present invention is to provide a drug compliance system which is primarily controlled by an automated preprogrammed computer which implements the interactions in the system so that health care providers and pharmacists can perform their medicine related activities in a normal fashion without requiring special programming or extra time on their part.

Another related object of the present invention is to provide a passive drug compliance system which automatically monitors compliance via the drug container used by the patient without requiring any input from the patient and transmits compliance information in real time from a wireless two-way transceiver in the portable medicine container carried by the patient.

An object of the present invention is to provide a wireless, web based drug compliance system for monitoring patient drug compliance.

Another object is to provide a wireless, web based drug compliance system that allows the interaction between patient, doctor, and pharmacist to ensure compliance.

Another object is to provide a wireless, web based drug compliance system that is wireless and is web based in its functionality using current web communication protocols.

Another object is to provide a wireless, web based drug compliance system that is provided at low or no cost to the patient.

Yet another object is to provide a wireless-web based drug compliance system with a wireless transceiver, and an interactive web site capable of data acquisition, data analysis, modeling and an intelligent application software to provide comprehensive solutions in dose administration of non-compliance patients.

Another objective where different types of drug dosage forms can be accommodated including solids, liquids and semisolids, which are to be administered to either adults or to children.

Yet another objective of the invention is that multiple medications can be accommodated into one combined medicine container capable of communicating wirelessly.

One further object of the present invention is to provide an interactive website capable of data acquisition, data analysis, and modeling to provide comprehensive solutions in non-compliance, which can be utilized in drug research and development and utilized a useful feedback to the user.

In another objective where the present invention fits into current healthcare setup and does not compromise the hygienity at the pharmacy

In brief, the wireless, web based drug compliance system according to the present invention substantially departs from the conventional concepts and designs of the prior art, and in so doing provides an apparatus primarily developed for the purpose of monitoring patient drug compliance.

In view of the foregoing disadvantages inherent in the known types of drug container now present in the prior art, the present invention provides a new wireless-web based drug compliance system which can be utilized for monitoring patient drug compliance.

The general purpose of the present invention, which will be described subsequently in greater detail, is to provide a new wireless, web based drug compliance system that has many of the advantages of the drug container mentioned heretofore and many novel features that result in a new wireless, web based drug compliance system which is not anticipated, rendered obvious, suggested, or even implied by any of the prior art drug container, either alone or in any combination thereof.

To attain this, the present invention generally comprises a wireless transceiver, a plastic container that holds or accommodates current pharmacy pill bottles, the programmable wireless transceiver and the patient's drugs, and software that controls the functioning of the wireless transceiver, and an interactive website for comprehensive solutions for dose administration non-compliance.

The present invention is a portable, wearable wireless web enabled dose administration compliance system. The non compliance in a true sense can not be prevented using any existing technologies such as in the referred patent/invention examples. However, the system of the present invention has the ability to address this issue more effectively by reminding the patient the dose taking times and correcting the missed dose event within a 15 minute time frame and well before the next dose time wirelessly and automatically.

The system of the present invention has the ability to record the dose administration event by tracking the event passively and not imposing the patient to input the event by pressing any buttons. The present system has the ability to communicate with the web system wirelessly using existing long distance wireless communication providers, and does not need a reader such as RFID reader or IR reader or a base station wired into the telephone lines for the dose administration event information to be recognized and recorded and reported.

The data is collected wirelessly from the bottle based on cap opening and used to predict compliance models pertaining to that patient which can be accessed by any healthcare provider for specific patient treatment using a code related to the patient's programmed wireless medicine container and subsequently the data can be used as a means for anonymous research related to drug compliance and of course the patient him/herself can access the information.

The missed dose reminding is done wirelessly. The prescription information including the dose administration instructions, drug:drug interactions, contraindications and other pertinent information is programmed in automatically and wirelessly from the computers of pharmacy during the prescription filling using only a unique code associated with the patient's programmable wireless medicine container. The pharmacist has no additional responsibility of programming or filling the data sheet besides his normal customary responsibilities and usual input into the pharmacist's computer which is programmed to send the information to the patient's portable programmable wireless medicine container and automatically program the patient's portable container.

The pill or other types of medicine containers are standard pharmacy containers and no special containers or canisters need to be fabricated. The container is equipped with child resistant caps therefore, no child can accidentally open the bottle. The bottle can have a sensor means such as thermal, pressure and lab on chip and can be utilized to wirelessly monitor the body temperature and blood pressure passively with no input from the patient and can have a non invasive or invasive means to collect information on blood chemistry such as blood glucose or creatinine levels by integrated currently available technologies into the present invention and transmit the data gathered from the patient wirelessly.

The present system uses two way communication wireless technology to communicate back and forth from the pill bottle or other medicine container. The bottle also can be a multi bottle component system to accommodate multiple drugs and still is wearable such as cell phone in the present sports model. The bottle can accommodate liquid medicines effectively useful for pediatric patients. The LCD display can play/present the information such as dose instructions and drug:drug interactions wirelessly. The system has the ability to circumvent the need for separate label preparation as the LCD displays the drugs name and dose needed to be taken all the times. The current invention can be configured with a ground position system, (GPS system) for the further two way communication applications.

There has thus been outlined, rather broadly, the more important features of the invention in order that the detailed description thereof may be better understood, and in order that the present contribution to the art may be better appreciated. There are additional features of the invention that will be described hereinafter.

The advantages of the present invention are further listed below with reference to the passive drug compliance system which functions within the existing healthcare system and normal drug taking habits of the user:

A portable pill bottle or other medicine container, which is wearable (always with the patient) and does not require separate communication system such as base.

A patient who tends to be non-compliant due to forgetfulness is not expected to remember to dock the bottle every day (so that healthcare professional can monitor patient's compliance). Hence, the present system does not rely on the patient's ability to remember.

The majority of non-compliance happens because of the patient's non-accessibility to their medicine bottle, hence the present invention which is portable/wearable with a limited/full supply of medication and which can remind the patient to take the medicine and contact the patient by phone or pager immediately upon missing a dosage presents a means for better drug compliance.

Due to hygiene/contamination concerns, the present portable medicine container does not require physical contact by a pharmacist for refills since the current medicine containers can be used as normally dispensed and those existing medicine containers fit into the programmed automatic monitoring containers carried by the patient. All programming can be done remotely and medication refill container can be dropped into the patient's own device directly.

There is a uniqueness in the present invention based on the concept of sharing non-compliance responsibility by using an independent organization which monitors drug compliance automatically instead of leaving the burden of drug compliance responsibility entirely up to the patient or the healthcare professional. Lack of drug knowledge, education, and discipline with a patient are underlying causes for non-compliance, hence a solution which requires the patient to be responsible can never be a good solution. This is a primary reason why the drug compliance system of the present invention provides a solution which will produce better drug compliance.

The system of the present invention has the ability to record the dose administration event by tracking the event passively and not imposing upon the patient to input the event by pressing any buttons.

The pharmacist has no additional responsibility for programming or filling out a data sheet besides his normal customary responsibilities which will automatically program the patient's portable wireless medicine container.

Other objects and advantages of the present invention will become obvious to the reader and it is intended that these objects and advantages be within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

These and other details of invention will be described in connection with the accompanying drawings, which are furnished only by way of illustration and not in limitation of the invention, and in which drawings:

FIG. 1 is a diagrammatic view of the drug compliance system of the present invention showing the components and interactions involved in the system;

FIG. 2 is a perspective view of the modified medicine container of the system of FIG. 1 showing a housing enclosing a wireless transceiver and a programmable means for communicating with the user, the housing having a means for attaching at least one drug containing means thereto with the attached medicine bottle shown;

FIG. 3 is a perspective view of the modified medicine container of the system of FIG. 2 without the attachable medicine bottle;

FIG. 4 is a perspective view showing various attachable cassettes which hold different numbers of medicine containers;

FIG. 5 is a perspective view of an alternate embodiment of the modified medicine container of the system of FIG. 2 having a series of rectangular medicine containers which could be removable or built in;

FIG. 6 is a perspective view of the modified medicine container of the system of FIG. 2 without the attachable medicine container and showing the device placed in a plug-in recharger unit;

FIG. 7 is a perspective view of a preferred embodiment of the medicine container of the system of FIG. 1 having a medicine container which is the primary container for the medicine having the wireless transceiver and a programmable means for communicating with the user built into the medicine container, which is capable of receiving a standard prescription pill or medicine bottle which fits into the medicine bottle;

FIG. 8 in a diagrammatic view of a portion of the system of FIG. 1 showing the particular interaction between a pharmacist and the patient using the system.

### BEST MODE FOR CARRYING OUT THE INVENTION

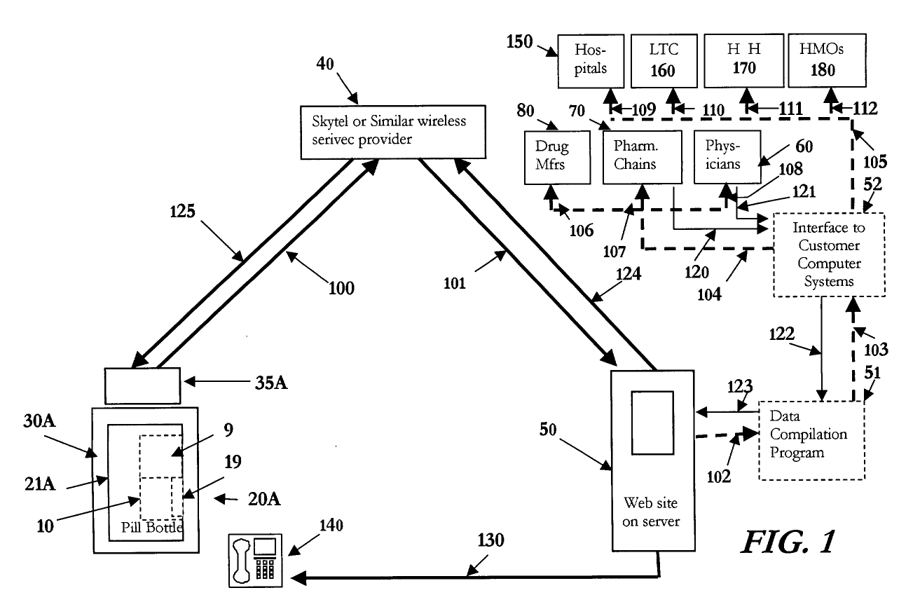

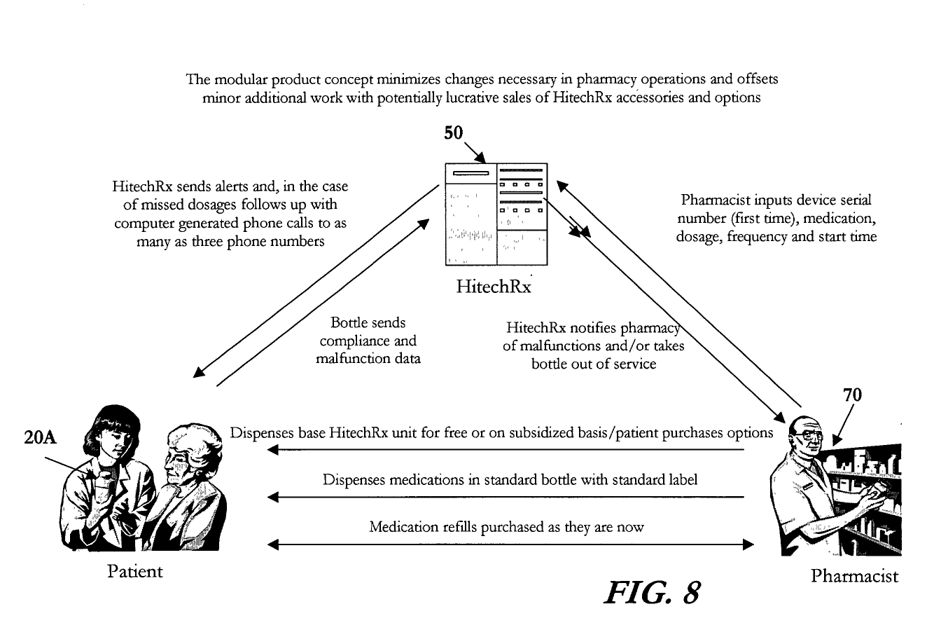

In FIGS. 1-8, a drug compliance system for passive drug compliance is applicable within the existing health care structure and existing communication systems due to the built-in efficiencies of the present system of the invention using existing technologies of communication and programmed for automatic drug compliance reporting as the user takes medicine in a normal way using the modified medicine container 20 and 20A which automatically informs the user in real time to take the medicine and automatically reports the taking of the medicine in real time and programmed to have the health care professional and the drug dispensing facility perform their functions in a normal way with the system in real time automatically programming the modified medicine container to signal the patient to take the appropriate medicine at the appropriate times and in real time to contact the patient via the communication means of the present system and via other existing communication means, such as cell phone, telephone, pagers and other means to take a missed dosage within a reasonable time of the allotted time as well as reporting anonymously the information about the compliance behavior to a variety of organizations within the health care system for compliance research.

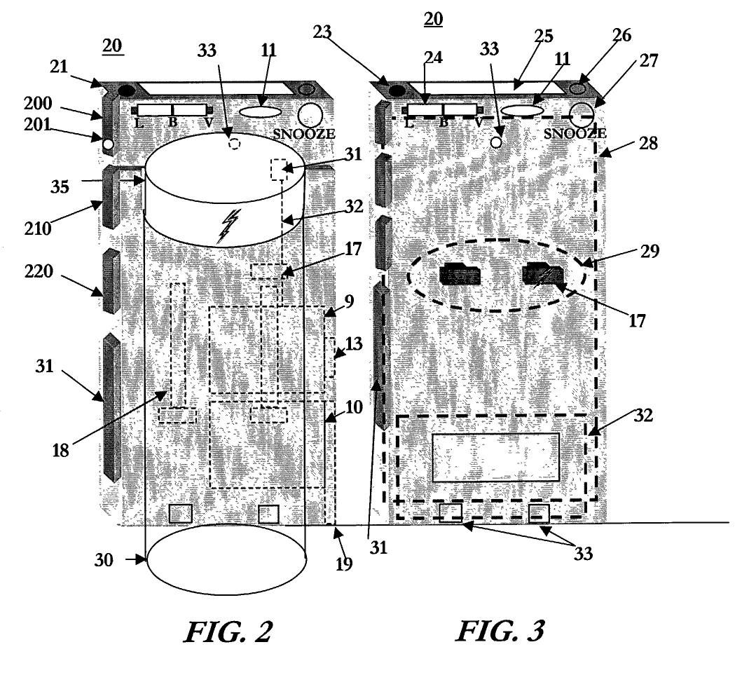

A portable modified medicine container 20 and 20A is capable of being transported on a body of a user using standard belt clips or straps or fitting into a pocket or purse due to the small size using miniaturized programmable electronic components. The modified medicine container 20 and 20A comprises a wireless transceiver 11 with an antenna 19 capable of two way communication over existing long distance telecommunications systems and at least one drug containing means 30 and 30A and 30B capable of containing a number of dosages of a drug therein, the at least one drug containing means having a wide-mouth opening 14 means for accessing at least one dosage of the drug, a monitoring means, such as the microswitch 41 of FIG. 7 capable of automatically detecting activity of the means for accessing the at least one dosage of the drug when the cover 35A is lifted to access the medicine to activate the microswitch. The microswitch communicates with the wireless transceiver 11 and so the modified medicine container automatically communicates in real time the accessing of the at least one drug via the wireless transceiver 11. The covers of FIGS. 2, 4, and 5 are also fitted with a microswitch for sensing compliance. The medicine container 20 and 20A further comprises a means for communicating with the user, such as, in FIGS. 3 and 7, a light means such as an alert light 23, a sound means such as a beeper 12, a vibrator 13, and a readable screen 25 and 25A, such as an LCD screen, and a programmable means 9, such as a microprocessor or chip, for controlling the means for communicating with the user and for controlling the wireless transceiver 10, the programmable means having a coding means unique to the modified medicine container 20 and 20A, so that the programmable means 9 is capable of communicating notification in real time that it is time to take a drug dosage at programmed time intervals to the user via the means for communicating with the user, such as the alert light 23, beeper 12, and vibrator 13 and the programmable means 9 is further capable of communicating information about the drug to the user via the LCD screen 25 and 25A.

The drug compliance system, as seen in FIG. 1, further comprises at remote programmable means such as at least one internet web site program 51 with a data compilation program controlled by an independent service provider associated with a web site on a web site server 50, the remote programmable means 51 being capable of communicating with the wireless transceiver 11 which may be via a wireless service provider 40 like Skytel, indicated by a wireless signal 124 to the wireless service provider and another wireless signal 125 from the wireless service provider to the modified medicine container 20 and 20A. The remote programmable means 51 capable of receiving real time communications from the wireless transceiver 11 and automatically sending real time communications to the wireless transceiver 11 related to drug dosage compliance, and the remote programmable means 51 being capable of communicating with a drug dispensing source computer, via communication means 103 to the computer systems interface 52 which may transmit phone line or wireless signals 104 and 107 to the pharmacy computer 70 and capable of communicating with a health care professional computer, such as a computer of a physician 60, via communication means 103 to the computer systems interface 52 which may transmit phone line or wireless signals 104 and 108. The drug dispensing source computer, such as at the pharmacy computer 70 and health care professional computer, such as at the physician's computer, each being capable of automatically communicating information to the wireless transceiver 11 via wireless or phone communication links 120 and 121 to the computer systems interface 52 and via communication links 122 to the data compilation program 51 and communication link 123 to the web site server 50 and wireless signal 124 to the wireless service provider 40 and wireless signal 125 to the wireless transceiver 11 of the modified medicine container 20A. The computers of the health care provider, such as a physician 60 and a pharmacist 70, are capable of automatically programming the programmable means 9 of the modified medicine container 20A in response to drug information and drug dosage timing and using the coding means unique to the modified medicine container 20A, by means of the normal input of information into at least one of the computers relative to the drug.

The remote programmable means 9 is capable of communicating with the wireless transceiver 11 and the health care computers 60 and 70 using internet communication means and internet communication protocols such as SMTP, POP3, and instant messaging or other similar internet communicating protocols which only require existing computers and an existing internet structure and also using existing wireless communication networks and companies, so that there is no need to set up a new and expensive communication infrastructure.

The means of normal input into at least one of the computers comprises the means used by a health care professional for inputting information into the health care professional's existing computer, such as the physician's computer 60, relative to a prescribed drug, and the means used by a drug dispensing source for inputting information into the drug dispensing source's existing computer, such as the pharmacist's computer 70, relative to a dispensed drug.

The drug dispensing source's inputting device may comprise a scanning means for scanning information from a label 15 normally attached to a standard drug housing means such as a pill bottle 16, as seen in FIG. 7, into the drug dispensing source computer, such as the pharmacist's computer 70, the label 15 containing information about the drug and the coding means for the modified medicine container 20 and 20A.

The remote programmable means 51 associated with the at least one web site 50, and the pharmacist's computer 70 and the physician's computer 60 are all capable of being programmed to respond in real time to the information about the drug and the coding means to send information to the wireless transceiver 11 to reprogram the programmable means 9 of the modified medicine container based on the drug information.

The remote programmable means 51 is capable of responding in real time to information transmitted or not transmitted from the wireless transceiver 11 concerning the timing of drug dosage compliance and send within a preprogrammed period of time a message via a communication means, such as one of the means for communicating with the user in the modified medicine container (alert light 23, beeper 11, vibrator 13, visual display 25 and 25A), a telephone 140 over line 130, a cell phone wirelessly, and a pager wirelessly to the user reminding the user to take a prescribed dosage of the drug.

As seen in FIG. 7, the means for accessing at least one dosage of the drug preferably comprises a child proof cap 35A (similar to the child proof cap 35 of the other Figures) and the monitoring means capable of automatically detecting activity of the means for accessing the at least one dosage of the drug comprises a microswitch 31 communicating between the child proof cap 35A and the at least one drug containing means. The microswitch may be located in the cap 35A or the top of the wide mouth 12 of the medicine holding container 30A. The microswitch 31 connects to the programmable means 9 by a wire 32 or other means to communicate in real time when the cap is opened and closed.

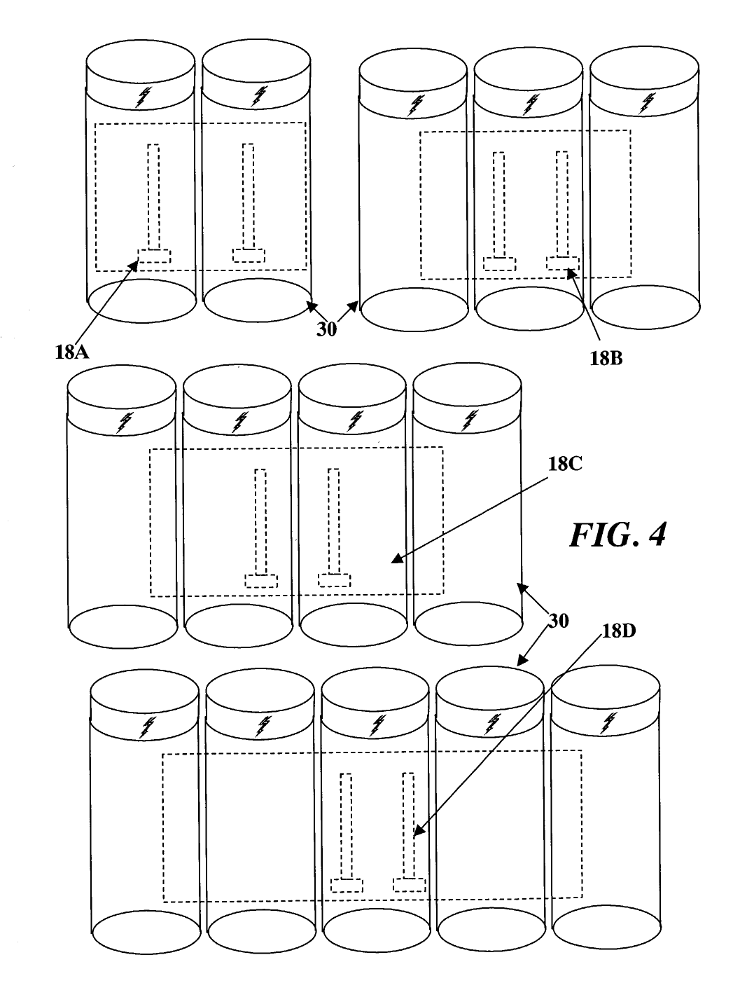

In FIGS. 2-6, the modified medicine container 20 comprises a housing 21 enclosing the wireless transceiver 10 and the programmable means 9, the housing having a means, such as a clamp-on cassette 18 and 18A-18D for attaching the at least one drug containing means thereto. The cassette holds the medicine container 20 and snaps onto posts 29 on the housing 21 and has an electrical connection 17 between the medicine container 20 and at least one of the posts. The medicine container may have a microswitch similar 31 to that of FIG. 7 and an electrical connector 32 to the cassette 18 and through the cassette to the housing at the electrical connector 17 of the cassette plug in connection 29 and to the programmable means 9 in the housing 21. The cassette 18 medicine containing means 30, as in FIG. 2 or may have a multiplicity of medicine containing means 30, and could be a be a two-container cassette 18A, a three-container cassette 18B, a four-container cassette 18C, a five-container cassette 18D, as in FIG. 4 or other configurations with different numbers of medicine containers 30.

A means for locking the cap 35, the means for accessing each of the multiplicity of drug containing means 30, may comprise a solenoid 33 normally engaging a groove 34 or other opening in the cap 35 or other locking means controlled to release at the programmed time for taking the medicine by the programmable means 9 which is capable of programming the means for locking to open at a prescribed time.

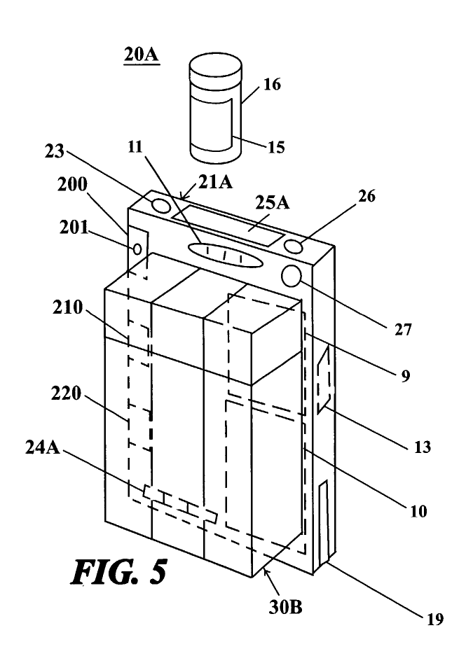

In FIG. 5, the housing 21A has alternately rectangular cross-section shaped medicine containing means 30B which may be removable or may be built in as a single piece with the housing 21A. The covers also have microswitches (not shown) similar to those of FIGS. 2 and 7. The standard drug dispensing bottle 16 may be placed in the medicine containers 30B or the medicine placed directly in the containers 30B.

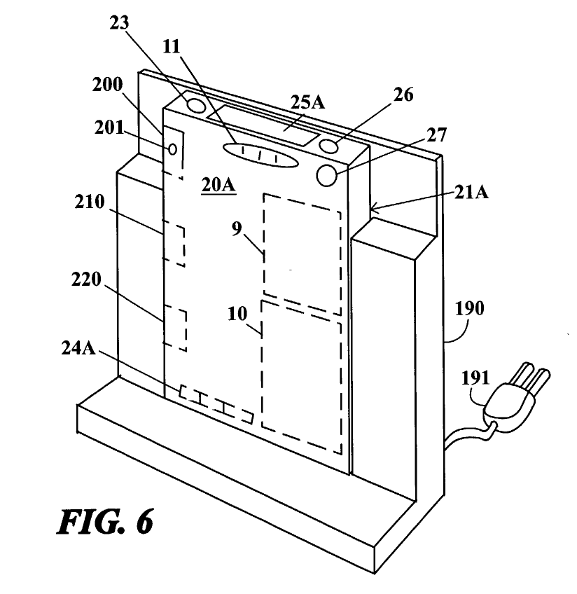

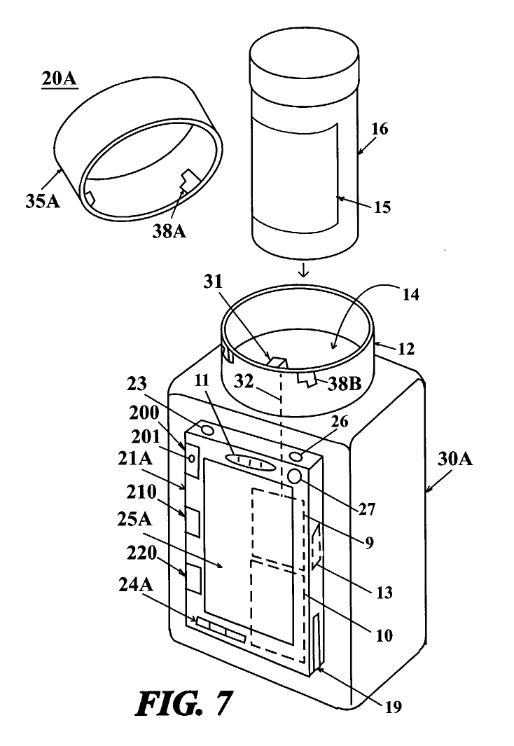

In FIG. 6, the housing 21A is shown without the medicine container attached with the housing 21A inserted in a conventional recharger 190 with a plug 191 for plugging in the recharger to recharge the portable modified medicine container 20A.

In FIGS. 2, 5, 6, an 7, the housing 21 and 21A further comprises a temperature sensor means 210 for thermal sensing data to obtain the temperature of a user by contact of the user with the temperature sensor means 210, a blood pressure sensor means 220 for pressure sensing for obtaining the blood pressure of a user by contact of the user with the blood pressure sensor means 220, and a blood chemistry sensor means 200 with a blood sampling means 201, such as a needle or other blood collecting means, for obtaining blood chemistry data, including blood glucose, creatinine and others, from the user by contact of the user with the blood sampling means 201. The temperature data, blood pressure data, and blood chemistry data may all be transmitted wirelessly in real time via the wireless transceiver 10.

In FIG. 7, a preferred embodiment of the modified medicine container 20A comprises a medicine containing means 30A forming the at least one drug containing means, the drug container housing an attached housing means 21A containing the wireless transceiver 10 with an antenna 19 and the programmable means 9. The container chamber can be used to dispense the medicine or a standard drug dispensing bottle 16 with a standard label 15 may be purchased from the pharmacist 70 or other medicine distribution source and fit into the drug containing means 30A. This avoids the need to bring the medicine containing means to the pharmacist with possible contamination issues related to contagious diseases. The label 15 may contain information about the medicine as is common in the health care industry and may also contain a bar code or other means that may be scanned into a computer at the pharmacy 70 including the coding means unique to the modified medicine container 20 and 20A.

The programmable means 9 for controlling the means for communicating with the user, the wireless transceiver 10, and for controlling the wireless transceiver comprises a programmable electronic means, such as a microprocessor or chip having a timing program and a program for activating the means for communicating with the user at programmed times and a means for activating the means for communicating with the user in response to signals received from the remote programmable means via the wireless transceiver 10.

The modified medicine container 20 and 20A comprises a lightweight casing sized to fit into a pocket of a user and having a means for attaching the casing to the clothing of the user, such as a belt clip or cord-attaching means.

In operation, the medicine containing means 30 and 30A signals the wireless transceiver 10 whenever the bottle is opened. Software controls the programmable means 9 for the functioning of the wireless transceiver 10 to receive input from a doctor/pharmacist regarding medication and dosage. The invention monitors patient compliance, in a passive way not requiring input from the user, through receipt of a signal from the wireless transceiver 10.

The wireless transceiver 10 is embedded in the plastic medicine containing means 30A or in a separate housing 21 with the medicine containing means 30 attached and it monitors the patient's dose administration through the opening of the bottle cap 35 and 35A. At each opening of the bottle the wireless unit signals the web server software 51 with the time of opening. If the patient does not open the bottle at the proper time for taking the medication a beeper prompts patient as a reminder to take medication and displays on LCD. In addition, after a reasonable wait time after the actual due time the server software notes the non-compliance, calls the patient on a phone 140 or cell phone, and signals the wireless unit to display a missed dose message. The web server software compiles compliance data for availability and access by patient, pharmacist 70 and doctor 60 as well as a host of other organizations in the health care community, including drug manufacturers 80, hospitals 150, LTC 160, home health care organizations 10, and HMOs 180, as seen in FIG. 1 via communication connections 104 and 106 for the drug manufacturers 80 and 105 and 109, 110, 111, and 112 for the others.

The self contained electronic reminder system comprises a wireless two way transceiver 10 with display features embedded in the dosage form dispensing casing which is capable of housing any type of dosage forms including solids, liquids and semisolid preparations. The device has the ability to communicate wirelessly via wireless transmission provider to the interactive website 50. The website in turn utilizes the intelligent application software to receive, analyze and model the data obtained based on dose administration habits for either individual patients or population of patients. The system provides an interactive website capable of data acquisition, data analysis, and modeling to provide comprehensive solutions in non-compliance, which can be utilized in drug research and development and utilized a useful feedback to the user.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is nor desired to limit the invention to the exact construction and operation shown and described, and accordingly, all suitable modifications and equivalents may be resorted to falling within the scope of the invention.

It is understood that the preceding description is given merely by way of illustration and not in limitation of the invention and that various modifications may be made thereto without departing from the spirit of the invention as claimed.

What is claimed is:

1. A drug compliance monitoring system for passive drug compliance applicable within the existing health care structure and existing communication systems, the system comprising:
a portable modified medicine container capable of being transported on a body of a user, the modified medicine container comprising a wireless transceiver capable of two way communication over existing long distance telecommunications systems and at least one drug containing means capable of containing a number of dosages of a drug therein, the at least one drug containing means having a means for accessing at least one dosage of the drug, a monitoring means capable of automatically detecting activity of the means for accessing the at least one dosage of the drug and capable of automatically communicating in real time the accessing of the at least one drug via the wireless transceiver, a means for communicating with the user; and a programmable means for controlling the means for communicating with the user and for controlling the wireless transceiver, the programmable means having a coding means unique to the modified medicine container, so that the programmable means is capable of communicating notification in real time that it is time to take a drug dosage at programmed time intervals to the user via the means for communicating with the user and the programmable means is further capable of communicating information about the drug to the user via the means for communicating with the user;
at least one internet web site program having a remote programmable means capable of communicating with the wireless transceiver, the remote programmable means being capable of receiving real time communications from the wireless transceiver and automatically sending real time communications to the wireless transceiver related to drug dosage compliance, and the remote programmable means being capable of communicating with a drug dispensing source computer via the internet and with a health care professional computer via the internet, the drug dispensing source computer and health care professional computer being each being capable of automatically communicating information to the wireless transceiver and capable of programming the programmable means of the modified medicine container automatically in response to drug information and drug dosage timing associated with the coding means unique to the modified medicine container and the normal input of information into at least one of the computers relative to the drug.

2. The system of claim 1 wherein the remote programmable means is capable of communicating with the wireless transceiver and the computers using internet communication means.

3. The system of claim 2 wherein the internet communication means comprises a communication means selected from the group of internet protocols such as SMTP, POP3, and instant messaging.

4. The system of claim 1 wherein the means of normal input into at least one of the computers comprises the means used by a health care professional for inputting information relative to a prescribed drug.

5. The system of claim 1 wherein the means of normal input into at least one of the computers comprises the means used by a drug dispensing source for inputting information relative to a dispensed drug.

6. The system of claim 1 further comprising a scanning means for scanning information from a drug bottle into the drug dispensing source computer wherein the information includes a coding means for the modified medicine container.

7. The system of claim 1 wherein the remote programmable means is capable of responding in real time to information transmitted and information not transmitted from the wireless transceiver concerning the timing of drug dosage compliance and send within a preprogrammed period of time a message via a communication means to the user reminding the user to take a prescribed dosage of the drug.

8. The system of claim 7 wherein the communication means comprises a communication means taken from the group of communication means comprising the means for communicating with the user of the drug container, a telephone, a cell phone, and a pager.

9. The system of claim 1 wherein the means for accessing at least one dosage of the drug comprises a child proof cap and the monitoring means capable of automatically detecting activity of the means for accessing the at least one dosage of the drug comprises a microswitch between the child proof cap and the at least one drug containing means.

10. The system of claim 1 wherein the modified medicine container comprises a housing enclosing the wireless transceiver, the housing having a means for attaching the at least one drug containing means thereto.

11. The system of claim 10 wherein the means for attaching the at least one drug containing means thereto comprises a holder attachable to the housing for receiving a multiplicity of drug containing means attached thereto.

12. The system of claim 11 wherein the holder further comprises a means for customized locking for accessing each of the multiplicity of drug containing means.

13. The system of claim 12 wherein the programmable means is capable of programming the means for locking to open at a prescribed time.

14. The system of claim 1 wherein the modified medicine container comprises a drug container forming the at least one drug containing means, the drug container housing the wireless transceiver and the programmable means.

15. The system of claim 1 the at least one drug containing means comprises a standard drug dispensing bottle.

16. The system of claim 1 wherein the at least one drug containing means comprises at least one container and closure capable of receiving a standard drug dispensing bottle therein.

17. The system of claim 1 wherein the means for communicating with the user comprises a means for communicating taken from the group of means for communicating comprising a light means, a sound means, a visible screen messaging means, and a vibrating means.

18. The system of claim 1 wherein the programmable means for controlling the means for communicating with the user and for controlling the wireless transceiver comprises a programmable electronic means having a timing program and a program for activating the means for communicating with the user at programmed times and a means for activating the means for communicating with the user in response to signals received from the remote programmable means via the wireless transceiver.

19. The system of claim 1 wherein the wireless transceiver comprises a communication device using a two-way wireless communicating technology.

20. The system of claim 1 wherein the modified medicine container comprises a lightweight casing sized to fit into a pocket of a user and having a means for attaching the casing to the clothing of the user.

21. The system of claim 1 further comprising a temperature sensor means for thermal sensing data for obtaining the temperature of a user which may be transmitted wirelessly.

22. The system of claim 1 further comprising a blood pressure sensor means for obtaining the blood pressure of a user which may be transmitted wirelessly.

23. The system of claim 1 further comprising a blood chemistry sensor means for blood chemistry data including blood glucose, creatinine and others which may be transmitted wirelessly.

24. The system of claim 1 further comprising an interactive website capable of data acquisition, data analysis, and modeling to provide comprehensive solutions in non-compliance, which can be utilized in drug research and development and utilized a useful feedback to the user.
